(19) United States
(12) Patent Application Publication
(10) Pub. No.: US 2020/0311647 A1
(43) Pub. Date: Oct. 1, 2020

(54) WORKFLOW-DRIVEN MANAGEMENT OF HARDWARE COMPONENTS

(71) Applicant: Hewlett Packard Enterprise Development LP, Houston, TX (US)

(72) Inventors: Sreenath Seshadri, Bangalore Karnatake (IN); Gnanaprakash Selvam, Bangalore Karnatake (IN); Pranay Nawghare, Bangalore Karnatake (IN); Ayush Shukla, Bangalore Karnatake (IN); Vinod Muraleedharan, Bangalore Karnatake (IN)

(21) Appl. No.: 16/370,804

(22) Filed: Mar. 29, 2019

(51) Int. Cl. G06Q 10/06; G06Q 10/00; G06F 11/07; G06T 19/00

(52) U.S. Cl. CPC G06Q 10/06398; G06T 19/006; G06F 11/0709; G06Q 10/20

(57) ABSTRACT

Aspects of workflow-driven hardware component management are disclosed. A workflow is generated for a job to be performed for management of a hardware component. The workflow includes a 3-Dimensional (3D) model of the hardware component. A job identifier may be allocated to a resource person associated with a resource device to provide job-based access rights for performance of the job. Directions are provided to the resource device based on the workflow to indicate actions to be taken for performing the job. The directions may include Augmented Reality images based on the 3D model. The job-based access rights are revoked on completion of the job.

### BACKGROUND

With increased usage of computing systems and networks, hardware components have to be often installed and maintained in geographically dispersed locations. Organizations might not always have employees at all locations and may have to rely on temporary workers at remote sites for managing the hardware components, such as for setting up switches/stacks, replacing transceivers or cables, replacing failed power supplies or fans, or re-doing an entire wiring closet. For example, in industries, such as banking, retail, and hospitality, where organizations are widely distributed with a few thousand branches using tens of thousands of hardware components, third-party workers are often hired to help with site-level hardware management.

### BRIEF DESCRIPTION OF FIGURES

Systems and/or methods, in accordance with examples of the present subject matter are now described, by way of example, and with reference to the accompanying figures, in which:

FIG. 1 illustrates an example network environment for workflow-driven hardware component management, in accordance with principles of the present subject matter.

FIG. 2 illustrates an example device implemented as a resource device, in accordance with principles of the present subject matter.

FIG. 3 illustrates an example system implemented as a workflow system, in accordance with principles of the present subject matter.

FIGS. 4a and 4b illustrate example scenarios for implementation of workflow-driven hardware component management, in accordance with principles of the present subject matter.

FIGS. 5a and 5b illustrate example graphical user interfaces (GUIs) shown on a resource device for work-flow driven hardware component management considering an example scenario where a 3-member stack of switches is to be installed, in accordance with principles of the present subject matter.

FIG. 6 illustrates an example method implemented by a resource device for workflow-driven hardware component management, in accordance with principles of the present subject matter.

FIG. 7 illustrates an example method implemented by a workflow system for workflow-driven hardware component management, in accordance with principles of the present subject matter.

### DETAILED DESCRIPTION

For management of hardware components, a technician typically has to visit the location where the hardware component is installed. Management of hardware components may include installation, maintenance, and replacement of equipment. Often, the location may be a remote site and hence the hardware component may have to be managed by resource personnel who may not have full access rights to the remote site. For example, in large distributed enterprises, where an administrator is located at the headquarters and centrally manages the network, help may be taken from operators at the remote sites for managing the hardware components. In another example, in an establishment that does not have a support team for managing the hardware components, services of a third party, such as a contractor, may be used for performing the job. The technician, such as an operator or contractor or temporary worker, who performs the hardware management is also referred to as a resource person.

In cases where a resource person is to be employed when a hardware component is to be replaced or installed, a user, such as an administrator, has to take care of shipping the hardware component to the remote site and then direct the resource person, for example, for identifying the correct equipment on which the replacement needs to be done, identifying the manner in which the hardware component is to be stacked or connected, and the like. As a result, the user has to be available for communicating with the resource person while the hardware management job is being performed.

Moreover, the resource person has to be provided with various access rights, such as access to the building, access to the wiring closet, wired or wireless access to network management systems, access to the equipment's location within the wiring closet as well as access to the right hardware (ports/modules), physical access to the component's console port for troubleshooting, and privileges to do certain tasks such as rebooting switches. Based on the job to be performed, the user has to specify when and for how long the access rights are to be given and ensure that the permissions are revoked when the resource person leaves the site. Nevertheless, knowledge of the network topology, device passwords, and external facing IP addresses may be exposed to the resource person when the wiring closet is accessed for an unrelated task, leading to a network security risk.

Various aspects of the present subject matter provide for workflow-driven hardware component management. While the following description is provided using networking hardware, such as switches, routers, access points, transceivers, power supply equipment, cables, fans, and the like, as examples, it will be understood that the principles of the present subject matter can be applied to the management any hardware component.

In one example, a workflow system may be implemented to allocate access rights to the resource person based on the hardware management job to be performed, communicate with a resource device associated with the resource person to ensure that the job is performed in a desired manner, and revoke the access rights on completion of the job. In one example, the workflow system may provide a workflow including directions for actions to be taken to perform the job to the resource device. The directions may include Augmented Reality (AR) images so that the resource person can accurately identify the connections to be made for the hardware component.

In one example, the workflow system may communicate with the resource device over a data network, such as a telecommunication network, which is separate from the local network to which the hardware component is connected at the remote site. Further, the workflow system may direct the resource device to a wiring closet of the hardware component using wayfinding techniques, thus ensuring that the resource person does not gain access to any other location in the remote site. The resource device may also validate the completion of the job by communicating with a network management system over the data network using secure channels.

Thus, the present subject matter helps in ensuring that knowledge of the enterprise network, and particularly the local network, is not exposed to the resource person as the resource device does not have to connect to the local network unless it is a part of performance of the job. Moreover, the user does not have to be available to the resource person while they are performing the job. Additionally, the allocation and revocation of access rights are automatic and based on the job and level of security clearance of the resource person. Thus, compliance with security policies of the organization can be ensured.

In some cases, the resource person may also be the administrator themselves and even in such cases, the present subject matter can help the administrator perform the job efficiently and ensure compliance with policies of the organization.

The systems and methods are further described in conjunction with appended figures. It should be noted that the description and figures merely illustrate the principles of the present subject matter. It will thus be appreciated that various arrangements that embody the principles of the present subject matter, although not explicitly described or shown herein, can be devised from the description and are included within its scope. Moreover, all statements herein reciting principles, aspects, and examples of the present subject matter, as well as specific examples thereof, are intended to encompass equivalents thereof.

In the figures, the left-most digit(s) of a reference number identifies the figure in which the reference number first appears. The same numbers are used throughout the figures to reference like features and components.

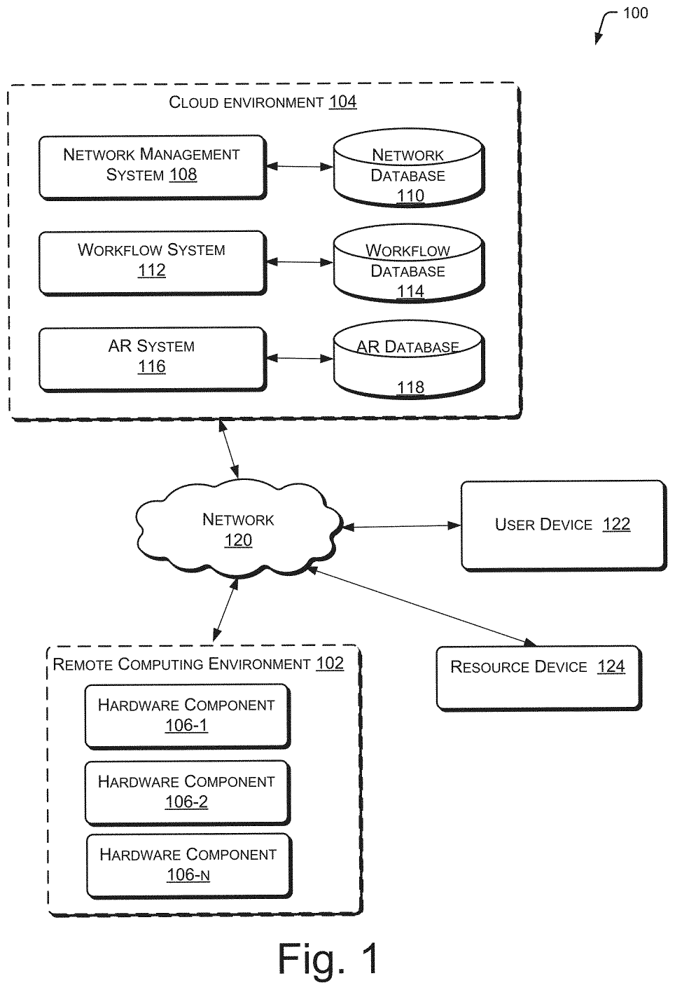

FIG. 1 illustrates an example network environment 100 for workflow-driven hardware component management, in accordance with an example of the present subject matter. The network environment 100 includes a remote computing environment 102 and a cloud environment 104. The remote computing environment 102 may be a site at which hardware components are to be managed. The remote computing environment 102 may correspond to a branch of an organization or an establishment where hardware components 106-1, 106-2, . . . 106-n may be installed for providing computing and networking services. While a single remote computing environment is illustrated for ease of depiction, it will be understood that there may be multiple remote computing environments associated with an organization and may collectively form an enterprise network. The hardware components 106-1, 106-2, . . . 106-n, may be individually referred to as a hardware component 106. Examples of the hardware component 106 include a switch, a router, an access point, a cable, power supply equipment, a transceiver, a gateway, and the like. Management of the hardware component 106 may refer to maintenance or replacement of an already installed hardware component or installation of a new hardware component.

To facilitate management of the hardware component 106, the cloud environment 104 may include a Network Management System (NMS) 108 associated with a network database 110, a workflow system 112 associated with a workflow database 114, and an Augmented Reality (AR) system 116 associated with an AR database 118. The NMS 108, the workflow system 112, and the AR system 116 may each be implemented as a computing system, which may be a desktop, a laptop, an on-premise server, a server in the cloud, a distributed system, or the like. Further, a part or all of the NMS 108, the workflow system 112, and the AR system 116 may be integrated into a common computing system, distributed or otherwise.

Similarly, the network database 110, the workflow database 114, and the AR database 118 may each be implemented as a database, which may be an integrated database or a distributed database. Further, some or all of the network database 110, the workflow database 114, and the AR database 118 may be integrated into a common database, distributed or otherwise. In some examples, a part or whole of the network database 110, the workflow database 114, and the AR database 118 may be integrated with the respective system that they are associated with, i.e., the NMS 108, the workflow system 112, and the AR system 116.

The remote computing environment 102 and the cloud environment 104 may be communicatively linked over a network 120. The network 120 may be a private network or a public network and may be implemented as a wired network, a wireless network, or a combination of a wired and wireless network. The network 120 can also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The NMS 108 may be implemented as a web application that can communicate with the hardware component 106 over the network 120. In one example, the communication may be done using various NMS protocols, such as Simple Network Management Protocol (SNMP), over a secure connection. In another example, other methods of hardware monitoring including RESTful APIs and events to monitor the functioning of the hardware component 106 and remotely manage software or firmware associated with the hardware component 106 may be used. In one example, the hardware component 106 may initially register itself with the NMS 108, for example, on installation or reboot, using a certificate generated using a Trusted Platform Module (TPM) chip embedded in the hardware component 106 to ensure secure communication. The secure communication between the hardware component 106 and the NMS 108 may conform to various security standards and may pass through an enterprise firewall in the remote computing environment 102.

Once the hardware component 106 is registered with the NMS 108, the NMS 108 may offer Northbound APIs (NBAPI) for programmability and automation of the hardware component 106 and other hardware components in the enterprise network. The term enterprise network as used herein refers to a network including various remote computing environments 102 that are associated with the organization. External web and non-web applications may query the APIs to know the state of the enterprise network. In one example, the NMS 108 may offer Webhooks so that other web applications that depend on the NMS 108 for information can be notified when particular events happen instead of polling the APIs frequently. Thus, the NBAPI and Webhooks help the NMS 108 to query the hardware component 106 periodically and also get notifications about events, such as hardware failures in the enterprise network.

In one example, a user, such as an administrator of the organization with which the remote computing environment 102 is associated, may use a user device 122 for communicating with the remote computing environment 102 and the cloud environment 104 to monitor the functioning and management of the hardware component 106. The user device 122 may be implemented as any computing device, such as a laptop, a desktop, a server, a mobile phone, a notebook, and the like. The user device 122 may communicate with the NMS 108 over a web interface to receive information regarding the status of the enterprise network and each of the hardware components 106 and provide the information to the user. In one example, an application may be installed on the user device 122 that may communicate with the NMS 108. In another example, the NMS 108 may be accessed using a web browser. The user device 122 also helps the user to provide commands to the NMS 108 over the web interface to manage functioning of the hardware 106, such as installing and upgrading software on the hardware 106, configuring the software, troubleshooting the software, and collecting data from the software for analytics over the web interface.

However, in case of failure of the hardware component 106 or in case a new hardware component 106 is to be installed in the remote computing environment 102, a technician, referred to as a resource person, may have to visit the site of the remote computing environment 102. The resource person may be employed for installation, maintenance, or replacement of the hardware component 106, referred to as management of the hardware component 106. In some examples, the resource person may be a third-party person who may have to be provided with sufficient access rights to perform a hardware management job without affecting the security of the enterprise network. Further, the resource person may have to be given direction regarding the hardware management job to be performed and the access rights have to be revoked once the hardware management job is completed.

For this, the user device 122 may communicate with the workflow system 112. The workflow system 112 may be implemented as a web application that can communicate with the user device 122 over the web interface through the application installed on the user device 122 or the web browser of the user device 122. The workflow system 112 may generate a workflow for the hardware management job based on information received from the NMS 108 and the user device 122. The workflow system 112 may take into consideration various factors to generate the workflow. In one example, in case of a workflow for installation of a hardware component 106, the workflow system 112 may consider how many hardware components 106, such as switches, access points and gateways, are to be installed, what is the order of installation for the equipment to be followed, how can the successful installation of a hardware component 106 be validated, how to setup a networking stack including step-by-step instructions and validation, access rights to be provided to the resource person, and the like. In another example, in case of a workflow for maintenance or replacement of a hardware component 106, the workflow system 112 may consider the type of the hardware component, such as power supply, fan tray, cable, transceiver, module, and the like, failure type, such as complete failure or partial failure, access rights to be provided to the resource person and the like.

In one example, different workflow templates may be stored in the workflow database for different hardware management jobs for different types of hardware components and, based on the hardware management job to be performed, the workflow system 112 may select and populate one or more workflow templates to generate the workflow for the hardware management job.

In one example, to be able to provide directions to the resource person, the workflow system 112 interacts with the AR system 116 to obtain 3D models of the hardware component 106 and integrates them into the workflow generated. The AR system 116 may be implemented as a web application that uses a library of 3D models of different types of hardware components to help the resource person identify the hardware components to be used in the hardware management job, such as the failed hardware component, the replacement hardware component, and the new hardware component to be installed, and to overlay troubleshooting information onto the hardware component 106 based on the workflow. The AR system 116 can thus help provide directions to the resource person, even if the target hardware component 106 is completely off the network and not in communication with the NMS 108, based on the appearance of the hardware component 106 and any machine-readable codes, such as barcode or QR-code, present on the hardware component 106. The AR system 116 is also helpful in the initial installation, such as racking and stacking, where the right hardware components have to be identified and placed in a certain order in a rack followed by interconnecting the right set of ports to achieve a desired outcome.

Once the workflow system 112 has generated the workflow in association with the AR system 116, the hardware management job may be allocated to the resource person by the workflow system 112. In one example, the resource person may use a resource device 124 that can communicate with the workflow system 112 over the network 120 to receive the job allocation and the workflow that provides directions for steps to be performed for the management of the hardware component 106.

The resource device 124 may be implemented as any computing device, such as a mobile phone, a notebook, and the like. The resource device 124 may communicate with the workflow system 112 and the AR system 116 over a web interface to receive information regarding the job allocated and steps to be performed in accordance with the workflow and provide the information to the resource person. In one example, the resource device 124 is capable of communicating over a data network, such as a telecommunication network, without accessing a local network in the remote computing environment 102. For example, the resource device 124 may communicate over a 4th Generation (4G) or 5th Generation (5G) network using a Subscriber Identity Module (SIM).

In one example, an application may be installed on the resource device 124 that may communicate with the workflow system 112 and the AR system 116. In another example, a web browser interface may be used to communicate with the workflow system 112 and the AR system 116. In some examples, the resource device 124 may interface with the NMS 108 to receive information about the state of the remote computing environment 102 and the hardware component 106.

Upon receiving information of allocation of a hardware management job, the resource device 124 informs the resource person of the job allocated and directs the resource person to perform the series of steps as per the workflow generated by the workflow system 112. The job allocation information can be used by the resource device 124 to obtain appropriate access rights for the resource person and gain access to the building and wiring closet where the job is to be performed. The resource device 124 may also communicate with sensors in the building, such as Bluetooth Low Energy (BLE) sensors, for navigating by wayfinding in the remote computing environment 102. The resource device 124 can also send location information of the resource person to the workflow system 112 to ensure that the resource person does not gain unauthorized access to other areas in the building. Further, the resource device 124 may communicate with Bluetooth adapters on the hardware components, such as switches/AP, to get access to the console based on the type of workflow and job allocated. The resource device 124 can include an AR camera to identify hardware components and connections to be made and receive the workflow directions as stepwise overlay information from the workflow system 112 and the AR system 116. Once the job is completed and validated, the workflow system 112 can cause the access rights to be revoked, thereby ensuring that no further access is available to the resource person.

Thus, aspects for the present subject matter provide for secure completion of the hardware management job without the resource person having to access the local network in the remote computing environment 102 or any specific configuration, such as guest access rights, being temporarily provided to the resource device 124. Further, provisioning and revocation of access rights to the resource person are performed automatically on allocation and completion of the job, thereby ensuring security of the enterprise network. Moreover, as the workflow system 112 and the AR system 116 provide information specifically about the hardware components to be managed, information about other hardware components and other network information is not exposed to the resource person. For enhanced security, the workflow system 112 and the AR system 116 may provide information specifically about the port on the hardware component on which the troubleshooting or connection installation is to be performed, thereby not exposing information about the communication happening over the other ports. For example, in failure scenarios, maintenance is to be performed on some ports on a switch, for example, for replacing failed transceivers, connected devices are shown for the affected ports, while information on what else is connected to the switch can be shielded.

Further, the communication between the resource device 124 and the workflow system 112 may be made location dependent to ensure that the resource person may access the NMS 108 when on site and when the workflow is enabled. As the resource device 124 may use indoor wayfinding techniques, such as BLE or a similar mechanism, for navigating, it can be ensured that the resource person has access to the authorized areas alone. Moreover, as the workflow system 112 provides stepwise direction to the resource person through a series of specific instructions, it reduces the chances of variance in outcome when using different resource persons and less skilled resource persons may also be employed.

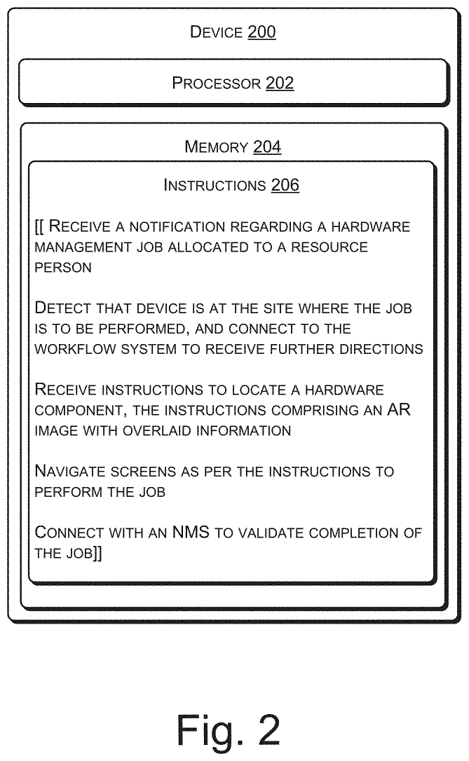

FIG. 2 illustrates an example device 200 as an implementation of the resource device 124, in accordance with principles of the present subject matter. The device 200 may be implemented as any mobile computing device, such as a mobile phone, a notebook, and the like, or may be a dedicated mobile terminal assigned to a resource person for hardware management in a remote computing environment. The device 200 may be capable of communicating over a data network, such as a 4G or 5G network, without access to the local network of a remote computing environment where a hardware management job is to be performed.

In one example, the device 200 includes a processor 202 and a memory 204 coupled to the processor 202. In addition, the device 200 may include other components, such as interfaces to communicate over a network and with external storage or computing devices, display, input/output interfaces, operating systems, applications, data, and the like, which have not been described for brevity.

The processor 202 may be implemented as a dedicated processor, a shared processor, or a plurality of individual processors, some of which may be shared. The memory 204 may be communicatively connected to the processor 202. Among other capabilities, the processor 202 may fetch and execute computer-readable instructions, including instructions 206, stored in the memory 204. The memory 204 may include any non-transitory computer-readable medium including, for example, volatile memory such as RAM, or non-volatile memory such as EPROM, flash memory, and the like.

In one implementation, the processor 202 may fetch and execute instructions 206 to enable the device 200 to help a resource person perform a hardware management job. The device 200 may receive a notification regarding a hardware management job allocated to the resource person. Once the resource person reaches the site, the device 200 can detect that it is at the site where the job is to be performed and connects to the workflow system 112 to receive further directions. Based on the job ID, the resource person can seek access to the building and wiring closet where the job is to be performed. The workflow system 112 may work with indoor wayfinding to direct the resource person to the location of the closet where the maintenance needs to be performed. Once it is determined that the resource person is inside the closet, for example, based on the location of the device 200, the workflow system 112 can provide directions for performing the job.

In one example, the workflow system 112 may direct the resource person to first locate the hardware component 106 to be managed. An AR image overlaid with information of the desired hardware component 106 may be displayed on the device 200 to assist in the identification of the hardware component 106 and to ensure that the job is performed on the right hardware component. Once the hardware component 106 is located, directions for the next step to be performed are displayed on the device 200. For example, in case a cable is to be replaced, the resource person will be directed to remove the connections of the cable and will receive a confirmation that the correct cable has been removed. The resource person will then be directed to connect a new cable. Once the connection is made, the workflow system 112 can verify from the NMS 108 that the cable is now operational and validate that the job has been completed. On validation, the device 200 will display a message stating the job has been completed and validated and will direct the resource person to leave the premises. Thereafter, the workflow system will revoke the access rights assigned to the resource person.

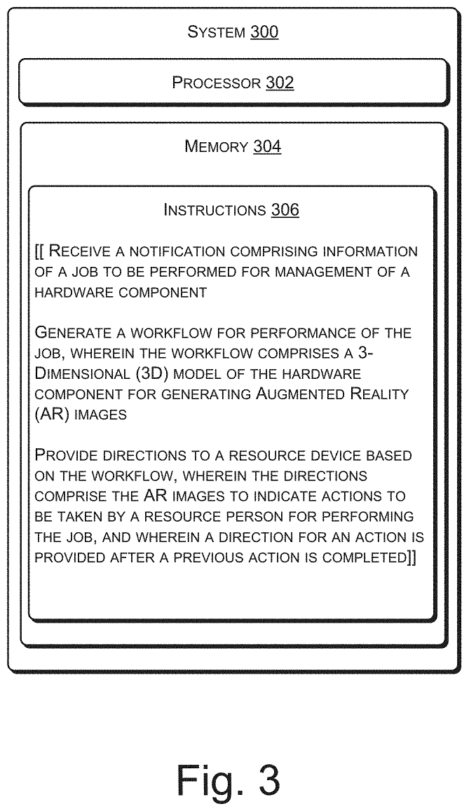

FIG. 3 illustrates an example system 300 as an example implementation of the workflow system 112. The system 300 may be implemented as any computing system, such as a desktop, a laptop, a server, a distributed computing system, or the like. In one example, the system 300 includes a processor 302 and a memory 304 coupled to the processor 302. In addition, the system 300 may include other components, such as interfaces to communicate over a network and with external storage or computing devices, display, input/output interfaces, operating systems, applications, data, and the like, which have not been described for brevity.

The processor 302 may be implemented as a dedicated processor, a shared processor, or a plurality of individual processors, some of which may be shared. The memory 304 may be communicatively connected to the processor 302. Among other capabilities, the processor 302 may fetch and execute computer-readable instructions, including instructions 306, stored in the memory 304. The memory 304 may include any non-transitory computer-readable medium including, for example, volatile memory such as RAM, or non-volatile memory such as EPROM, flash memory, and the like.

In one implementation, the processor 302 may fetch and execute instructions 306 to enable the system 300 to coordinate with various other systems and devices for workflow-driven management of hardware components. In one example, the system 300 may receive a notification that a hardware management job is to be performed. In one example, the hardware management job may be installation of a new hardware component at in a remote computing environment. For example, a user, such as an administrator, may initiate a process for installation of a new hardware component from a user device and the system 300 may receive the notification for the job from the user device. In another example, the hardware management job may be maintenance or replacement of a hardware component at in the remote computing environment. For example, an NMS may notify the system 300 and the user device that a hardware component in the remote computing environment has failed. The system 300 may send a message to the user device to have a series of tests performed remotely by the user to confirm that the hardware component has failed and is to be replaced. On confirmation, the user device may send the notification for the job to the system 300.

The system 300 may then generate an appropriate workflow to direct a resource person for performing the job. In one example, the workflow may be generated based on previously stored workflow templates. The workflow may include 3D models of the hardware component to be managed that may be obtained from an AR system. The workflow may also include wayfinding instructions to direct the resource person from an entrance of the remote site to a particular rack in which the maintenance needs to be performed. The system 300 may then notify a resource device that a hardware management job is to be performed and may provide the date, time, and location details for performing the job. The system 300 may receive a confirmation from the resource device indicating that the resource person has accepted the job.

At the desired date and time, once the resource device reaches the site, the resource device may communicate with the system 300 to gain access to the building and find the wiring closet using indoor wayfinding. The system 300 may enable appropriate access rights for the resource person to allow the resource person to perform the job without exposing knowledge of other hardware components or network parameters to the resource person. Further, the system 300 can provide step by step directions overlaid with AR images to the resource device to enable the resource person to perform the job. Once the job is performed, the system 300 can validate from the NMS that the job is completed and may then revoke the access rights provided to the resource person.

Thus, the hardware management job may be completed without the administrator having to be available to direct the resource person. Moreover, the resource device communicates with the system 300 over an external data network, such as a telecommunication network and does not need access to the local network of the remote computing environment. Further, the system 300 ensures that the resource device and the resource person are not exposed to knowledge unrelated to the job and hence, enhances the security of the whole operation.

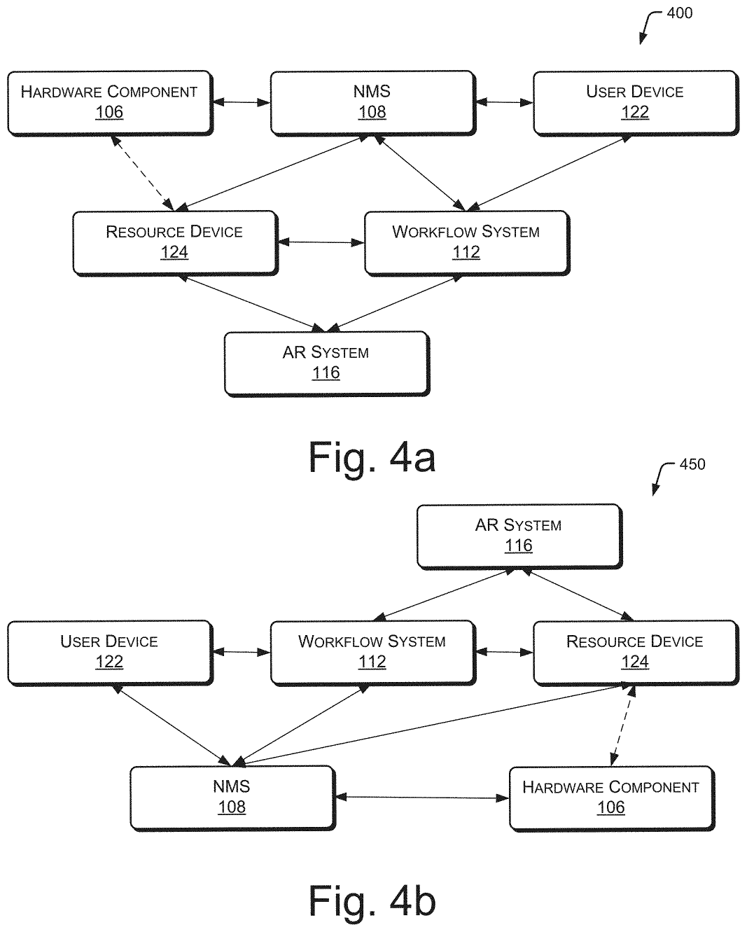

Example scenarios for implementation of workflow-driven hardware component management are discussed with reference to FIGS. 4a and 4b.

FIG. 4a illustrates an example scenario 400 for implementation of workflow-driven hardware component management and shows how a replacement of a hardware component may be performed in accordance with principles of the present subject matter. In the case of a hardware failure in a hardware component 106, the equipment sends a notification to the NMS 108 to determine if the hardware component 106 is still reachable on the network 120 or in the case where the entire hardware component 106 is down, the NMS 108 detects the absence and notifies the user device 122. The NMS 108 also notifies the workflow system 112 about the failure so that a set of validation tasks may be sent to the user device 122.

Based on the prompt from the workflow system 112, the user device 122 runs tests on the hardware component 106 using the NMS 108 to do a basic validation of the failed hardware and to make sure that it is not a false alarm. If a redundant component, such as a redundant power supply or a fan fails, the hardware component 106 will still be available on the network to run tests. In the case where the hardware component 106 is completely down, neighboring hardware components can be queried to gather data on when the equipment went down and gather other details for troubleshooting purposes. One method includes keeping track of Link Layer Discovery Protocol (LLDP) based neighbor information to know when a neighboring switch went down.

Once the failure is validated and enough data is gathered by the user device 122, the user device 122 indicates to the workflow system 112 that the hardware component 106 is to be replaced. The workflow system 112 then triggers a part-replacement workflow and directs the user device 122 to place a replacement order with the manufacturer and ship it to the location of the remote computing environment 102. The user device 122 interacts with an ordering system and sends data about the failed part, location of the remote computing environment, and tracking information for the shipped replacement component to the workflow system 112. The workflow system 112 can keep track of the information using the workflow database 114 and provide the information as part of the workflow provided to the resource device 124. The workflow system 112 notifies the resource device 124 about the upcoming job and notifies when the replacement part is received at the remote computing environment 102.

Before the visit, the resource person can review the nature of the replacement job and engage in preparations needed for the job. The resource person then arrives at the remote computing location and uses the Job ID displayed on the resource device 124 to get access to the building as well as the special access to the wiring closet where the hardware failure has occurred. Access to the building may be automated by interfacing the resource device 124 with the building access control system to prevent the need for manual verification as well as to plug any potential holes in the security process that might arise from manual intervention.

During the entire duration of the visit, the resource person uses the resource devices' data connection to stay connected with the workflow system 112 and the NMS 108, if applicable, and does not need access to the wired or wireless local network. While the resource device is connected to the NMS via a public Internet system, end to end encryption in communication, such as SSL, may be used to ensure that no proprietary data is accessible outside the communication channels. This additional layer of precaution prevents any deliberate or unintended attacks on the network from the resource device 124.

The workflow system 112 then provides step by step directions to the resource device 124 to enable the resource person to perform the job. For example, the resource person may be asked to first validate if the replacement part is correct by scanning the barcode of the received package as well as the barcode on the component inside to validate the shipment. Then, using wayfinding technology, such as Bluetooth Low Energy (BLE) beacons or BLE sensors embedded in Access Points, the resource device 124 may direct the resource person to the building, floor, and location of the closet. This is to prevent the resource person from getting lost within the building and also to prevent any deliberate digressions to other closets or locations where information about the network may be gathered. Any digressions from the prescribed path will be identified and notified to the workflow system 112 for logging and also to the user device 122 for monitoring.

The resource device 124 switches ON an Augmented Reality (AR) camera to scan hardware components 106 that match the physical description of the target hardware component 106 which is to be managed. In one example, 3D models of network equipment may be made available to the AR camera for it to use the physical dimensions as well as distinguishing features and the orientation of the camera to determine if the target in front of the camera is the hardware component 106 in question. For this, the resource device 124 may communicate with the AR system 116 as will be understood to a person skilled in the art.

Most equipment in networking closets have a machine-readable sticker on them, such as QR-code or barcode, and depending on how AR-friendly the code on the hardware is, the resource device 124 might be able to scan multiple codes in one go or might require the resource person to take the camera up close to each hardware component to validate if it is the target hardware component.

Once the failed equipment is identified, the resource device 124 uses information from the NMS 108 to highlight the failed hardware component. In the case of a failed cable, the port on which the cable is connected is highlighted using AR or if the power supply has failed, the resource device 124 directs the resource person to view back of the switch where it highlights the failed power supply. This is useful since there might be more than one power supply or ports and using AR leads to an error-free replacement.

In one example, the workflow includes a video of how the hardware component is to be replaced, which may be played by the resource device 124. This can be useful if the resource person is not familiar with the hardware component 106 or if there are some precautions that the resource person is to be made aware of before the replacement.

The resource person may be then directed to replace the hardware component 106 while taking the precautions highlighted in the tutorial. Once the replacement is complete, the resource device 124 or the workflow system 112 contacts the NMS 108 to check if the failed hardware component is back online and runs tests on the replaced hardware component. If the replacement is successful, the workflow system 112 and the user device 122 are notified of the outcome. If the job was not successful, the resource device 124 provides troubleshooting tips to the resource person as directed by the workflow system 112. In cases where the workflow system 112 is to use the output of the serial console of the hardware component 106, the resource device 124 connects to the hardware component 106 via Bluetooth to get access. Connection to the Bluetooth device on the hardware component 106 may be secured by one of the already established mechanisms such as per-device Bluetooth passwords that the NMS 108 already has access to and provides to the resource device 124. The output from the console is collected by the resource device 124 without the resource person connecting a cable to the console or knowing the Bluetooth password.

Once the job is successfully done, the resource person is led out of the building using the wayfinding technology, where they may be asked to surrender access badges and sign any job sheets applicable to the location. The resource person can then mark the job as completed on the resource device 124, which notifies the workflow system 112 after which the details of the job are erased from the memory of the resource devices 124 leaving only a high-level overview of the job on the resource device 124. This helps to ensure that network related information is not inadvertently left on the resource device 124.

In some examples, the resource person may be pre-approved for getting more access and accordingly, the level of information displayed to the resource person and retained on the resource device 124 may be varied.

FIG. 4b illustrates an example scenario 450 for implementation of workflow-driven hardware component management and shows how installation of a hardware component may be performed in accordance with principles of the present subject matter. In one example, the workflow system 112 sets up the series of instructions to be followed as well as how the user uses the user device 122 to ensure that the installation is complete before the resource person leaves the site.

For installation of a new hardware component 106 at a remote site, the workflow may be initiated by a user, such as an administrator, where they specify the list of equipment to be installed including the order in which the equipment is to be connected. Even though the equipment might function even when connected out of order, providing the order to the resource person helps the user track if all instructions were followed and if the equipment was correctly installed.

Considering a case where a site might have one WAN router, few Access Points and a few switches and sometimes the switches might have to be stacked. The user, through the user device 122, specifies the list of hardware components 106 as well as the configuration that the NMS 108 has to push to each equipment when they are successfully setup along with the order in which the hardware component 106 is to be setup. The workflow system 112 takes these specifications and breaks them down into simple steps to generate a workflow that the resource person can follow.

The workflow system 112 notifies the resource device 124 about the upcoming job and notifies when the new hardware will be received at the remote computing environment. Before the visit, the resource person reviews the nature of the installation job and engages in preparations needed for the task. When the resource person arrives at the location, they may go through the same steps as described above with reference to FIG. 4a. The resource device 124 will provide details of the site as well as the equipment that they need to unbox and install on the site.

In case the switches need stacking, the racking and stacking process normally followed by network administrators, will be initiated by the workflow system 112 to ensure that the right switches are racked in order before they are stacked together to form a single switch. The resource device 124 will use the AR system 116 to highlight the right set of ports to connect the uplinks, LACP/trunks as well as stacking cables to be connected.

Further, similar to the process described above with reference to FIG. 4a, the workflow system 112 may provide step by step directions to the resource person through the resource device 124 for installation of the new hardware component. In one example, instead of playing a video of replacement, the resource device 124 can use AR to highlight the right ports on which the connections need to be made. Further, the resource device 124 may communicate with the NMS 108 as discussed above, to validate the installation.

Thus, the resource person can navigate through a set of screens displayed on the resource device 124 as directed by the workflow system 112 to connect the right set of ports to successfully setup the hardware component 106. This is further explained using example screens or Graphical User Interfaces (GUIs) displayed to the resource person.

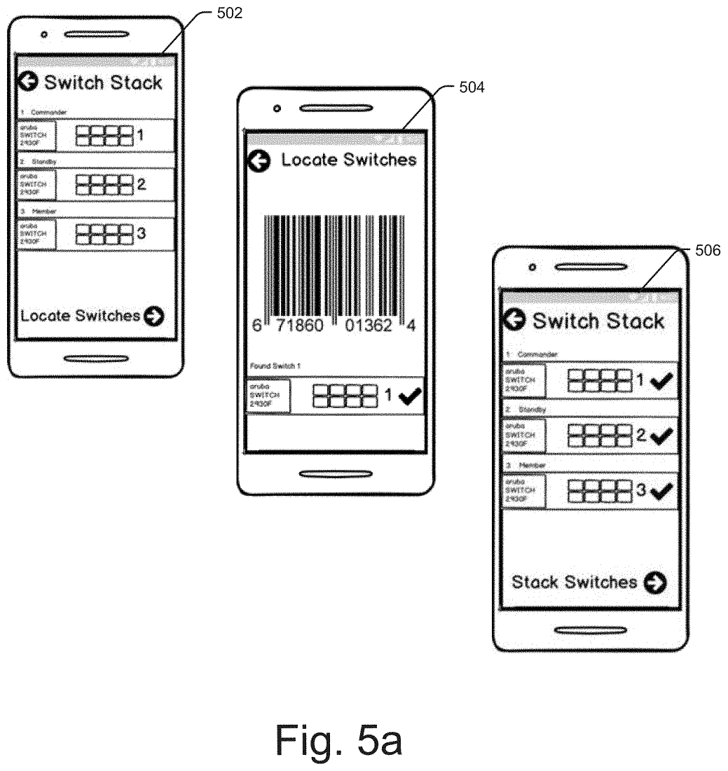

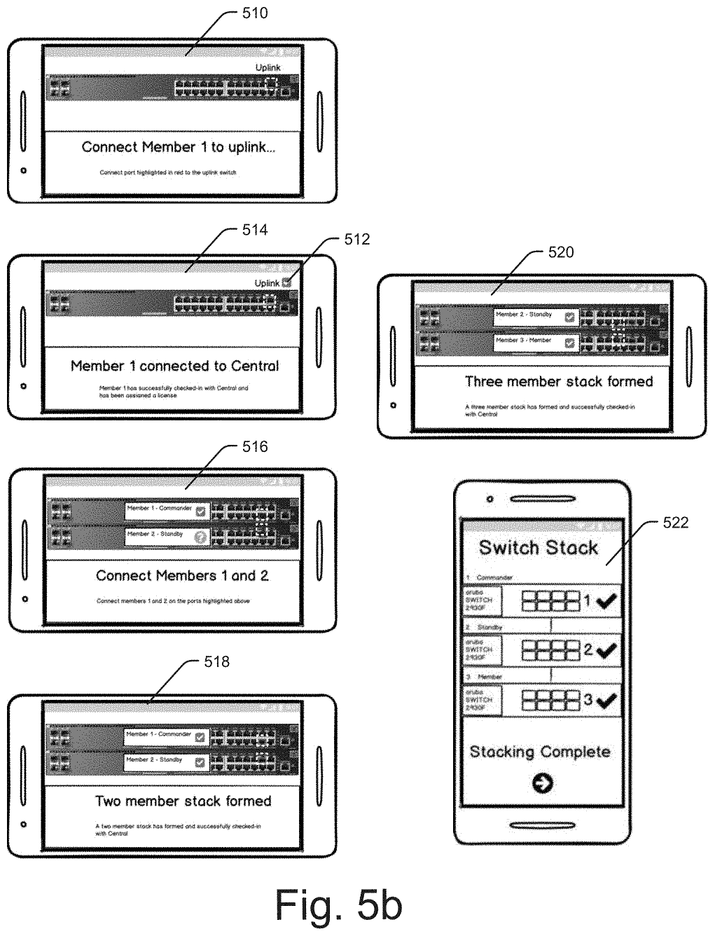

FIGS. 5a and 5b illustrate example graphical user interfaces (GUIs) shown on a resource device for work-flow driven hardware component management considering an example scenario where a 3-member stack of switches is to be installed. In one implementation, once the resource person has gained access to the location and is ready to begin installation of the switches, the resource person is shown the GUI 502 for switch stack installation, which asks the resource person to first locate the switches. For this, the resource person may unbox the switches and scan an identifier, such as a barcode, of each of the switches for verification by the resource device. For example, GUI 504 illustrates the confirmation provided by the resource device upon locating the first switch. Once all three switches are located, the GUI 506 may be displayed indicating that all three switches have been successfully located.

The resource device may then take the resource person through the workflow for installation of the switch stack using AR images. For example, the GUI 510 may be shown to instruct the resource person to connect switch-1 to uplink, i.e., to the network. One portion of the GUI 510, such as the top portion, has the camera view showing a view of the switch as captured by the camera of the resource device with the uplink port highlighted, for example, by a red colored rectangle overlaid via Augmented Reality. The resource person can connect a cable from the highlighted uplink port to an uplink switch or Digital Subscriber Line (DSL) modem to connect switch-1 to a network. Once the switch-1 is connected and is able to communicate with the NMS, the NMS notifies the workflow system, which in turn notifies the resource device that the uplink has been successfully established. On receiving the notification, the AR overlay information of the uplink port changes, for example, from the red colored rectangle to a green colored rectangle, with additional overlay information, such as a tick mark 512, indicating that the Uplink is now available, as shown in GUI 514.

The GUI 516 is then shown indicating that switch-2 is to be now connected, with similar AR overlay information to indicate the ports of switch-1 and switch-2 that are to be connected. Once the switches are connected as indicated and a confirmation is received by the NMS, the NMS notifies the workflow system, which in turn notifies the resource device that the second switch has been successfully connected as shown in GUI 518. The process continues till the third switch is also connected as shown in GUI 520 that shows a confirmation of formation of three-member stack. The resource device then shows the GUI 522 to indicate that the stacking is complete, and the resource person can therefore end the workflow and finish the exit procedures.

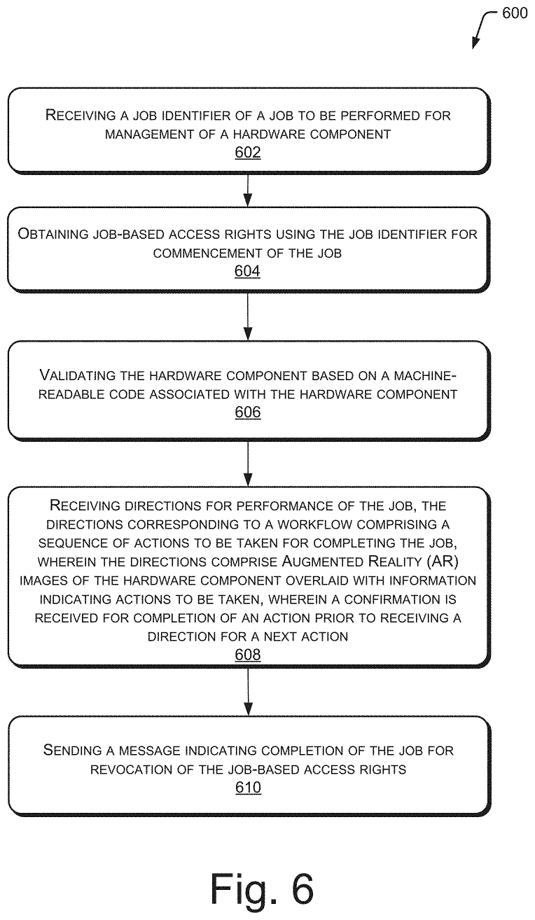

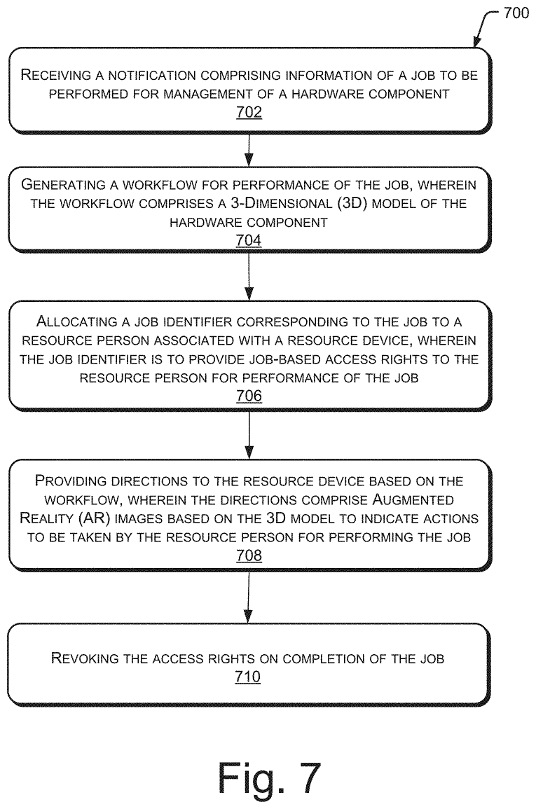

Aspects of the present subject matter will now be described with reference to methods implemented by various systems and devices. FIG. 6 illustrates an example method 600 implemented by a resource device for workflow-driven hardware component management, in accordance with principles of the present subject matter. FIG. 7 illustrates an example method implemented by a workflow system for workflow-driven hardware component management, in accordance with principles of the present subject matter.

The order in which the methods 600 and 700 are described is not intended to be construed as a limitation, and some of the described method blocks can be combined in a different order to implement the methods, or alternative methods.

Furthermore, the methods 600 and 700 may be implemented in any suitable hardware, computer-readable instructions, or combination thereof. The steps of the methods 600 and 700 may be performed by either a device/system under the instruction of machine executable instructions stored on a non-transitory computer readable medium or by dedicated hardware circuits, microcontrollers, or logic circuits. For example, the methods 600 and 700 may be performed by the resource device 124 or workflow system 112, respectively, in the network environment 100 and may implement various scenarios, such as those described with reference to FIGS. 4a, 4b, 5a, and 5b as discussed above but not repeated here. Herein, some examples are also intended to cover non-transitory computer readable medium, for example, digital data storage media, which are computer readable and encode computer-executable instructions, where said instructions perform some or all of the steps of the methods 600 or 700.

With reference to FIG. 6 and method 600, at block 602, a job identifier of a job to be performed for management of a hardware component is received. The job may include, for example, maintenance of the hardware component, replacement of the hardware component, or installation of the hardware component.

At block 604, job-based access rights may be obtained using the job identifier for commencement of the job. In one example, the job-based access rights comprise rights to access a wiring closet in which the hardware component is installed. To assist in locating the wiring closet, wayfinding techniques may be implemented, for example, using Bluetooth Low-Energy (BLE) beacons.

At block 606, the hardware component may be validated based on a machine-readable code associated with the hardware component.

At block 608, directions for performance of the job may be received. The directions may correspond to a workflow comprising a sequence of actions to be taken for completing the job and may include AR images of the hardware component overlaid with information indicating actions to be taken. In one example, a confirmation is received for completion of an action prior to receiving a direction for a next action. In one example, the directions are received over a data network that is different from a local network to which the hardware component is connected.

At block 610, a message indicating completion of the job may be sent for revocation of the job-based access rights. In one example, prior to sending the message, a communication may be sent to a network management system over the data network to validate the completion of the job.

With reference to FIG. 7 and method 700, at block 702, a notification including information of a job to be performed for management of a hardware component may be received. In one example, the job corresponds to installation of the hardware component and the notification comprises a list of hardware components to be installed, a sequence of installation of the hardware components, and configuration to be provided to each of the hardware components. In another example, the job corresponds to replacement of the hardware component and the notification comprises the job corresponds to replacement of the hardware component and the notification comprises a list of hardware components to be replaced and configuration information for each of the hardware components.

At block 704, a workflow for performance of the job may be generated. The workflow may include a 3-Dimensional (3D) model of the hardware component. In one example, to generate the workflow, a set of workflow templates may be obtained from a workflow database and a set of 3D images may be obtained from an AR database based on the information of the job. The workflow templates may be populated based on the information of the job and the 3D images to obtain the workflow.

At block 706, a job identifier corresponding to the job may be allocated to a resource person associated with a resource device. The job identifier may be used to provide job-based access rights to the resource person for commencement of the job.

At block 708, directions may be provided to the resource device based on the workflow. The directions can include Augmented Reality (AR) images based on the 3D model to indicate actions to be taken by the resource person for performing the job. An AR image may include an image of the hardware component overlaid with a symbol to highlight a part of the component on which an action is to be taken with accompanying text to indicate the action to be taken. In one example, a direction for an action is provided after a previous action has been completed. For example, the directions may include a direction to validate the hardware component based on a machine-readable code associated with the hardware component. On validation of the hardware component, a next direction may be provided to connect the component as specified and further directions may be provided sequentially.

At block 710, the access rights may be revoked on completion of the job. In one example, completion of the job may be validated prior to revoking the access rights. For validating the completion of the job, communication may be established with a network management system to confirm functioning of the hardware component. The communication may be established over a secure channel to ensure security of the enterprise network.

Although examples for the present disclosure have been described in language specific to structural features and/or methods, it should be understood that the appended claims are not necessarily limited to the specific features or methods described. Rather, the specific features and methods are disclosed and explained as examples of the present disclosure.

1. A method comprising:
receiving a notification comprising information of a job to be performed for management of a hardware component;
generating a workflow for performance of the job, wherein the workflow comprises a 3-Dimensional (3D) model of the hardware component;
allocating a job identifier corresponding to the job to a resource person associated with a resource device, wherein the job identifier is to provide job-based access rights to the resource person for performance of the job;
providing directions to the resource device based on the workflow, wherein the directions comprise Augmented Reality (AR) images based on the 3D model to indicate actions to be taken by the resource person for performing the job; and
revoking the access rights on completion of the job.

2. The method of claim 1, wherein the job corresponds to installation of the hardware component and the notification comprises a list of hardware components to be installed, a sequence of installation of the hardware components, and configuration to be provided to each of the hardware components.

3. The method of claim 1, wherein the job corresponds to replacement of the hardware component and the notification comprises a list of hardware components to be replaced and configuration information for each of the hardware components.

4. The method of claim 1, wherein generating the workflow comprises:
obtaining a set of workflow templates from a workflow database, a set of 3D images from an AR database, and configuration of the hardware component based on the information of the job; and
populating the workflow templates based on the information of the job and the 3D images to obtain the workflow.

5. The method of claim 1, wherein a direction for an action is provided after a previous action has been completed.

6. The method of claim 1, wherein an AR image comprises an image of the hardware component overlaid with a symbol to highlight a part of the component on which an action is to be taken with accompanying text to indicate the action to be taken.

7. The method of claim 1, wherein the directions comprise a direction to validate the hardware component based on a machine-readable code associated with the hardware component.

8. The method of claim 1, comprising validating completion of the job prior to revoking the access rights, wherein the validating is based on communication with a network management system to confirm functioning of the hardware component.

9. A method comprising:
receiving a job identifier of a job to be performed for management of a hardware component,
obtaining job-based access rights using the job identifier for commencement of the job;
validating the hardware component based on a machine-readable code associated with the hardware component;
receiving directions for performance of the job, the directions corresponding to a workflow comprising a sequence of actions to be taken for completing the job, wherein the directions comprise Augmented Reality (AR) images of the hardware component overlaid with information indicating actions to be taken, wherein a confirmation is received for completion of an action prior to receiving a direction for a next action; and
sending a message indicating completion of the job for revocation of the job-based access rights.

10. The method of claim 9, wherein the directions are received over a data network that is different from a local network to which the hardware component is connected.

11. The method of claim 10, comprising communicating with a network management system over the data network to validate the completion of the job.

12. The method of claim 9, wherein the job-based access rights comprise rights to access a wiring closet in which the hardware component is installed.

13. The method of claim 12, comprising providing navigation assistance to locate the wiring closet based on wayfinding technology.

14. The method of claim 9, wherein the job is one of maintenance of the hardware component, replacement of the hardware component, and installation of the hardware component.

15. A system comprising:
a processor; and
a memory coupled to the processor and storing instructions executable by the processor to:
receive a notification comprising information of a job to be performed for management of a hardware component, wherein the job is one of maintenance of the hardware component, replacement of the hardware component, and installation of the hardware component;
generate a workflow for performance of the job, wherein the workflow comprises a 3-Dimensional (3D) model of the hardware component for generating Augmented Reality (AR) images; and
provide directions to a resource device based on the workflow, wherein the directions comprise the AR images to indicate actions to be taken by a resource person for performing the job, and wherein a direction for an action is provided after a previous action is completed.

16. The system of claim 15, wherein the instructions are executable by the processor to receive a message indicative of failure of the hardware component and notify a user device to run tests on the hardware component for confirming the failure of the hardware component

17. The system of claim 15, wherein the instructions are executable by the processor to validate completion of the job based on communication with a network management system associated with a local network to which the hardware component is connected.

18. The system of claim 15, wherein the instructions are executable by the processor to generate the workflow for installation of a plurality of hardware components in a sequence received from a user device.

19. The system of claim 15, wherein the instructions are executable by the processor to assign access rights to the resource person based on the job and a level of security clearance of the resource person, and to revoke the access rights on completion of the job.

20. The system of claim 15, wherein the directions include a direction to locate a wiring closet of the hardware component based on wayfinding.
